(19) United States
(12) Patent Application Publication
(10) Pub. No.: US 2018/0342887 A1
(43) Pub. Date: Nov. 29, 2018

(54) HANDHELD DEVICE

(71) Applicant: Matthew Orlic, Newington (AU)

(72) Inventor: Matthew Orlic, Newington (AU)

(21) Appl. No.: 15/604,410

(22) Filed: May 24, 2017

(51) Int. Cl. H02J 7/00; A45C 11/18; A45C 1/02; A45C 1/06

(52) U.S. Cl. CPC H02J 7/0068; H02J 7/0045; A45C 1/06; A45C 11/182; A45C 1/02; H02J 7/0047

(57) ABSTRACT

Disclosed herein is a handheld device 10 that performs multiple functions. The device 10 comprises a rechargeable battery unit 12 comprising one or more lithium-ion cells. A power input terminal 14 is electrically connected to the rechargeable battery unit 12, the at least one power input terminal being adapted for connection to mains electricity or another an external source of electrical power. A power output terminal 16 is also electrically connected to the rechargeable battery unit 12, the at least one power output terminal being adapted for connection to a portable electronic device to deliver power from the rechargeable battery unit 12 to the portable electronic device. A charge control module 18 is connected to the power input terminal 14 to control recharging of the cells of the rechargeable battery unit 12 with power received from the at least one power input terminal. A communications device 20 is electrically connected to the rechargeable battery unit 12. The communications device 20 comprises an antenna for receiving a radio signal from an external device and a transmitter for transmitting a radio signal to an external device. A housing 22 encloses the charge control module 18, the communications device 20 and the rechargeable battery unit 12.

### TECHNICAL FIELD

The present disclosure relates to a handheld device.

### BACKGROUND

A problem that many people will be familiar with is being inundated with a plethora of personal items, especially personal electronic devices, that have become part of daily living. How to keep these devices powered for long periods, without having to plug in to mains electricity, can present a significant problem, even with the advances that have been made in battery technology. Carrying around a large number of electronic and non-electronic personal items can also present a problem in itself, and it is not uncommon for a person to need to travel with a bag or case to transport all of their essential daily items.

The most usual method of charging electronic devices is via connection to mains electricity. However, as the charging process generally takes at least an hour, this charging method is a hindrance to a user who needs to be on the go. In order to address this problem, separate stand-alone power supplies or “powerbanks” have been developed to allow a user to charge electronic devices whilst out and about, without having to resort to plugging in to mains electricity. However, whilst addressing the problem of charging whilst mobile, this solution worsens the problem of a user having to carry large numbers of items.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, and variations such as “comprises” or “comprising”, and the word “include”, and variations such as “includes” or “including”, will be understood to imply the inclusion of a stated element, integer or step, or group of elements, integers or steps, but not the exclusion of any other element, integer or step, or group of elements, integers or steps.

### SUMMARY

In a first aspect, there is provided a handheld device comprising:

a rechargeable battery unit comprising one or more cells;

at least one power input terminal electrically connected to the rechargeable battery unit, the at least one power input terminal being adapted for connection to an external source of electrical power;

at least one power output terminal electrically connected to the rechargeable battery unit, the at least one power output terminal being adapted for connection to a portable electronic device to deliver power from the rechargeable battery unit to the portable electronic device;

a charge control module connected to the at least one power input terminal to control recharging of the one of more cells with power received from the at least one power input terminal;

a communications device electrically connected to the rechargeable battery unit, the communications device comprising an antenna for receiving a radio signal from an external device and a transmitter for transmitting a radio signal to an external device, the handheld device being preconfigured such that:
upon the communications device receiving a predetermined radio signal from an external device, the communications device automatically transmits a predetermined radio signal to an external device, or
upon the communications device receiving a predetermined radio signal from an external device, the handheld device is configured to automatically emit an optical or audible alert; and

a housing enclosing the charge control module, the communications device and the rechargeable battery unit.

The handheld device may be a multifunction handheld device. A cover portion may be connected to and extend at least partially around the housing, the cover portion comprising a plurality of slots that open into pockets, each of the slots and pockets being configured to slidably receive a credit card. At least some of the pockets may partially overlap.

The predetermined radio signal that causes the communications device to transmit a predetermined radio signal to an external device may be different to the predetermined radio signal that causes the handheld device to automatically emit an optical or audible alert.

The handheld device may comprise a button for manual actuation by a user, wherein actuation of the button causes the transmitter to transmit a predetermined radio signal to an external device.

The communications device may be a Bluetooth communications device.

The charge control module and communications device may be controlled via a common printed circuit board.

The communications device may have a dedicated power supply. The dedicated power supply may comprise a reserved portion of power from the rechargeable battery unit. Alternatively, the dedicated power supply may comprise a back-up on-board power supply separate from the rechargeable battery unit, wherein the communications device is electrically connected to both the back-up on-board power supply and to the rechargeable battery unit.

The at least one power input terminal may comprise a USB connector, such as a micro USB receptacle.

The at least one power output terminal may comprise a USB connector, such as a USB plug. The at least one power output terminal may comprise a smart phone charge input connector, such as a lightning connector. The at least one power output terminal may be extendable from the housing.

The at least one cell may comprise at least one lithium-ion cell or at least one lithium-ion polymer cell. The rechargeable battery unit may have a capacity of at least 1000 mAh, at least 1500 mAh, at least 2000 mAh or approximately 2500 mAh.

The handheld device may be pocket sized.

The handheld device may function as a wallet, such as a credit card wallet. Alternatively, the handheld device may function as a clutch purse.

A clip may be connected relative to the housing for facilitating connection of the handheld device to an anchor point on a user, such as a user's waist belt.

### BRIEF DESCRIPTION OF DRAWINGS

An exemplary embodiment of principles disclosed herein will now be described, by way of example only, with reference to the accompanying drawings, in which:

FIG. 1 is a schematic perspective view of a handheld device embodying principles disclosed herein;

FIG. 2 is a schematic perspective view of the device of FIG. 1, shown with its power output terminal extended;

FIG. 3 is a schematic perspective view of the device of FIG. 1, shown with its power output terminal extended and its protective cap removed;

FIG. 4 is a schematic perspective view of the opposite side of the device of FIG. 1; and

FIG. 5 is a schematic circuit diagram of the handheld device of FIG. 1.

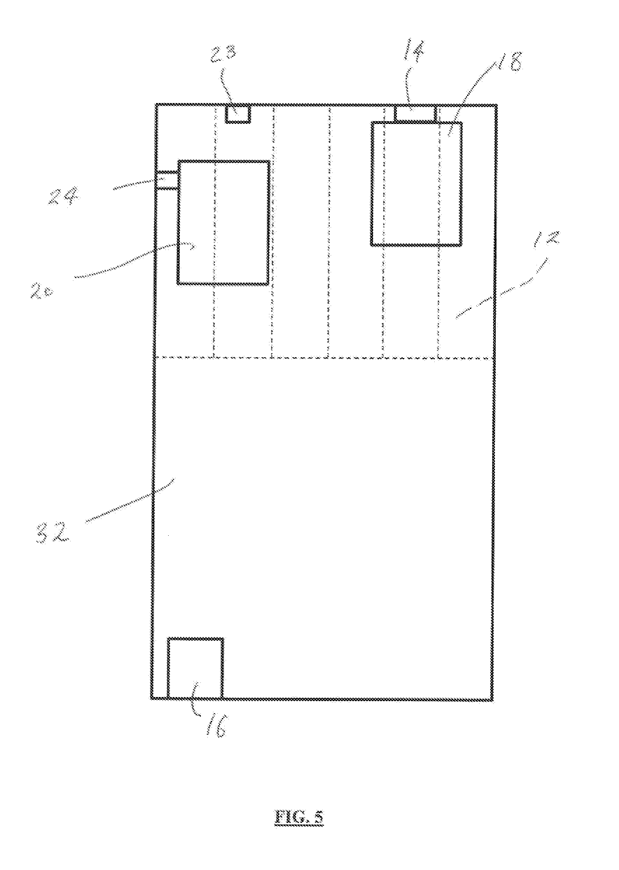

### DESCRIPTION OF EMBODIMENTS

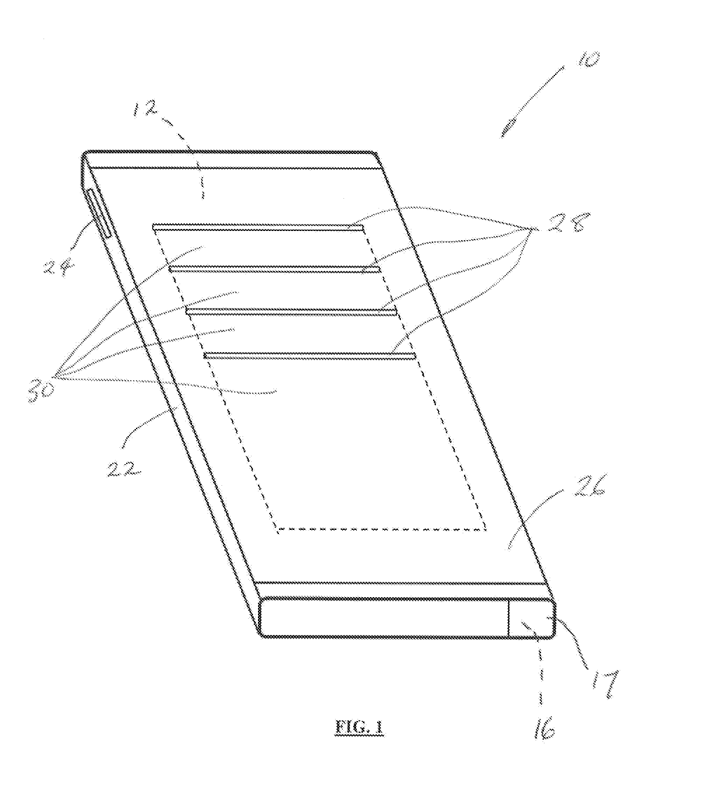

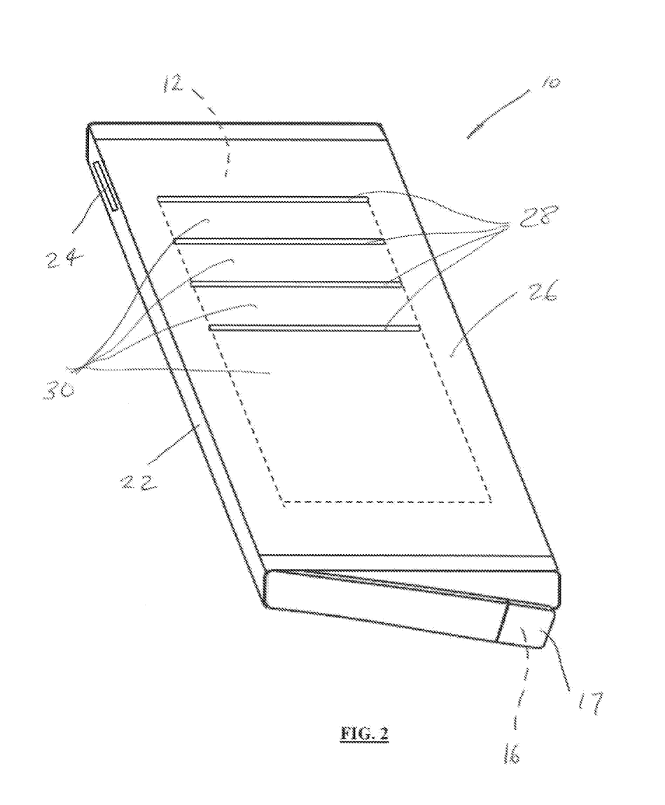

Referring to FIGS. 1 and 2, there is shown a handheld device 10 that performs multiple functions. The device 10 comprises a rechargeable battery unit 12 comprising one or more lithium-ion cells. A power input terminal 14 is electrically connected to the rechargeable battery unit 12, the at least one power input terminal being adapted for connection to mains electricity or another an external source of electrical power. A power output terminal 16 is also electrically connected to the rechargeable battery unit 12, the at least one power output terminal being adapted for connection to a portable electronic device to deliver power from the rechargeable battery unit 12 to the portable electronic device. A charge control module 18 is connected to the power input terminal 14 to control recharging of the cells of the rechargeable battery unit 12 with power received from the at least one power input terminal. A Bluetooth communications device 20 is electrically connected to the rechargeable battery unit 12. The communications device 20 comprises an antenna for receiving a radio signal from an external device and a transmitter for transmitting a radio signal to an external device. A housing 22 encloses the charge control module 18, the communications device 20 and the rechargeable battery unit 12.

The device 10 is associated with an external device, such as a smart phone or tablet device. The device 10 is preconfigured such that, upon the communications device 20 receiving a first predetermined radio signal from an external device, the communications device 20 automatically transmits a predetermined radio signal to an external device to assist in locating the device 10 if it has been misplaced. The predetermined radio signal or a modified version thereof including location information may be retransmitted by the external device.

The device is also preconfigured such that, upon communications device 20 receiving a different predetermined radio signal from an external device, the handheld device 10 automatically emits an optical alert via a LED or other light source 23, or an audible alert via a speaker to assist in locating the device 10 if it has been misplaced. The LED or light source 23, or a separate indicator, may be provided in device 10 to indicate the state of charge of the rechargeable battery unit 12.

The device 10 comprises a button 24 for manual actuation by a user, wherein actuation of the button causes the communications device 20 to transmit a predetermined radio signal to an external device. This function can be utilised to assist in locating a misplaced external device that is associated with the device 10.

A cover portion 26 is connected to and extends at least partially around the housing 22. The cover portion 26 comprises a plurality of slots 28 that open into pockets 30, each of the slots and pockets being configured to slidably receive a credit card. The pockets 30 partially overlap.

The charge control module 18 and communications device 20 share the same printed circuit board 32. However, communications device 20 has a dedicated power supply, which may be a reserved portion of power from the rechargeable battery unit 12. Alternatively, communications device 20 may receive power from the rechargeable battery unit 12 and also have a back-up on-board power supply separate from the rechargeable battery unit 12

In the illustrated embodiment, the power input terminal 14 comprises a micro USB receptacle. However, any other form of power input terminal may alternatively or additionally be used.

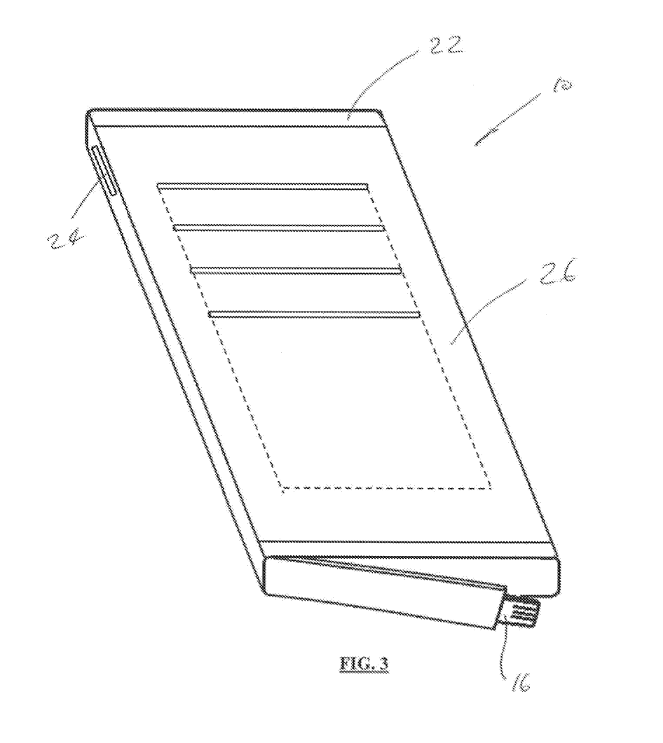

As shown in FIG. 3, the power output terminal 16 comprises a smart phone charge input connector, specifically a “lightning” connector. A removeable cap 17 protects power output terminal 16. The power output terminal 16 may be removeable and replaceable with a different power output terminal to configure the device 10 for recharging an external device with a different charging port. Alternatively, the power output terminal 16 may comprise a USB connector, such as a USB receptacle, for receiving a USB plug on a charging cable plug for an external device. As shown in FIGS. 2 and 3, the power output terminal 16 is extendable from the housing 22 to allow the device 10 to be connected directly to an external device without the need for a separate charging cable.

In the illustrated embodiment, the rechargeable battery unit 12 has a capacity of 2500 mAh.

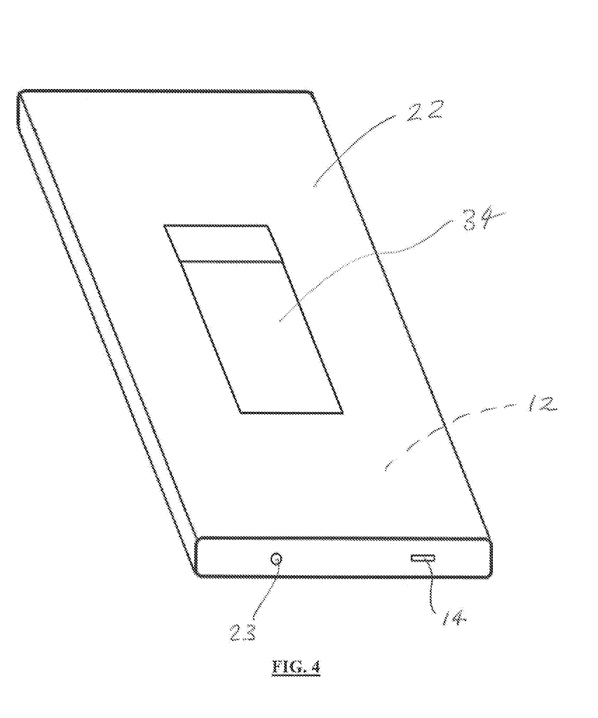

In the embodiment illustrated in FIGS. 1-4, the handheld device takes the form of a pocket sized wallet, such as for carrying credit cards. In other embodiments, the device 10 may be configured as a clutch purse. As shown in FIG. 4, a clip 34 is connected relative to the housing 33 for facilitating connection of the device 10 to an anchor point on a user, such as a user's waist belt.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. Examples of possible modifications/variations include, but are not limited to:
the rechargeable battery unit 12 comprising a different type of rechargeable cell, such as lithium-ion polymer cells;
the rechargeable battery unit 12 having a different capacity;
different and/or additional power input terminals may be provided; and/or
different and/or additional power output terminals may be provided.

1. A handheld device comprising:
a rechargeable battery unit comprising one or more cells;
at least one power input terminal electrically connected to the rechargeable battery unit, the at least one power input terminal being adapted for connection to an external source of electrical power;
at least one power output terminal electrically connected to the rechargeable battery unit, the at least one power output terminal being adapted for connection to a portable electronic device to deliver power from the rechargeable battery unit to the portable electronic device;
a charge control module connected to the at least one power input terminal to control recharging of the one of more cells with power received from the at least one power input terminal;
a communications device electrically connected to the rechargeable battery unit, the communications device comprising an antenna for receiving a radio signal from an external device and a transmitter for transmitting a radio signal to an external device, the handheld device being preconfigured such that:
upon the communications device receiving a predetermined radio signal from an external device, the communications device automatically transmits a predetermined radio signal to an external device, or
upon the communications device receiving a predetermined radio signal from an external device, the handheld device is configured to automatically emit an optical or audible alert; and
a housing enclosing the charge control module, the communications device and the rechargeable battery unit.

2. A handheld device according to claim 1, being a multifunction handheld device.

3. A handheld device according to claim 1, comprising a cover portion connected to and extending at least partially around the housing, the cover portion comprising a plurality of slots that open into pockets, each of the slots and pockets being configured to slidably receive a credit card.

4. A handheld device according to claim 1, wherein the predetermined radio signal that causes the communications device to transmit a predetermined radio signal to an external device is different to the predetermined radio signal that causes the handheld device to automatically emit an optical or audible alert.

5. A handheld device according to claim 1, comprising a button for manual actuation by a user, wherein actuation of the button causes the transmitter to transmit a predetermined radio signal to an external device.

6. A handheld device according to claim 1, wherein the communications device is a Bluetooth communications device.

7. A handheld device according to claim 1, wherein the charge control module and communications device share a common printed circuit board.

8. A handheld device according to claim 1, wherein the communications device has a dedicated power supply.

9. A handheld device according to claim 8, wherein the dedicated power supply comprises a reserved portion of power from the rechargeable battery unit.

10. A handheld device according to claim 8, wherein the dedicated power supply comprises a back-up on-board power supply separate from the rechargeable battery unit, and wherein the communications device is electrically connected to both the back-up on-board power supply and to the rechargeable battery unit.

11. A handheld device according to claim 1, wherein the at least one power output terminal is extendable from the housing.

12. A handheld device according to claim 1, wherein the at least one cell comprises at least one lithium-ion cell or at least one lithium-ion polymer cell.

13. A handheld device according to claim 1, wherein the rechargeable battery unit has a capacity selected from the group consisting of: at least 1000 mAh, at least 1500 mAh, at least 2000 mAh and approximately 2500 mAh.

14. A handheld device according to claim 1, being pocket sized.

15. A handheld device according to claim 1, being a device selected from the group consisting of: a wallet for storing at least credit cards, and a clutch purse.

16. A handheld device according to claim 1, comprising a clip connected relative to the housing for facilitating connection of the handheld device to an anchor point on a user, such as a user's waist belt.
